(19) United States
(12) Patent Application Publication
(10) Pub. No.: US 2010/0140539 A1
(43) Pub. Date: Jun. 10, 2010

(54) METHOD AND COMPOSITION TO FORM A FLEXIBLE CRUST ON A SUBSTRATE

(76) Inventors: Glenn Weagle, Vancouver (CA); Tibor Horvath, Vancouver (CA)

Correspondence Address: Smiths IP, Suite #330, 1508 West Broadway, Vancouver, BC, V6JIW8, CA

(21) Appl. No.: 12/328,623

(22) Filed: Dec. 4, 2008

(51) Int. Cl. C09K 3/22

(52) U.S. Cl. 252/88.1

(57) ABSTRACT

The invention relates to a compound of two main components, a polysaccharide and a borate provider, that form a flowable, penetrating liquid when mixed, then cross-link and gel to form a stable, flexible crust when applied to a substrate. The crust stabilizes the substrate and prevents loss of particulate matter, but can be softened or mechanically worked to allow access to the substrate, for example for further processing. Additives may be used to control specific properties of the crust.

### FIELD OF THE INVENTION

This invention relates to a liquid gel formed from a binary system that can be applied to a substrate to stabilize the substrate and to prevent the loss of particulate matter, such as dust.

### BACKGROUND OF THE INVENTION

Stabilization of substrates is important to avoid particulate loss from the substrates, which can pollute the atmosphere and can result in lost material. Substrates, as the term is used herein, include any mass comprising smaller pieces of material that can be moved, blown or washed away from the main mass, including, but not limited to, gravel, rocks, stones, sand, coal, soil, clay, garbage, wood (such as sawdust), minerals (such as sulfur), and combinations of such materials. Stabilization, as the term is used here, includes suppression of formation of dust or other particulate matter, as well as prevention of substrate movement or erosion by wind and/or water.

Particular applications in which substrate stabilization is important include gravel or unpaved roads, parking lots, driveways and runways; quarries and mines; construction sites; cargo carriers, such as railcars, barges and ships; recreational areas such as campgrounds, trails, golf courses, car or horse racetracks, arenas and campgrounds; storage and stockpile sites, such as tailings ponds; industrial areas such as steel mills, saw mills, truck terminals and railroad yards; and landfill and dumping areas.

Prior art stabilization and suppression methods include simple wet coverage, in which a substrate or product stream is dampened with water or other fluid, so that it generates less dry dust, and prevents any dust generated from becoming airborne. Chemicals, such as surfactants, can be added to the wetting fluid to increase the surface coverage and penetration into the substrate. The wetting agent may also take the form of a foaming fluid. In wetting type systems, the suppression is only effective until the fluid dries. In windy conditions, this can happen quickly as the natural evaporation rate increases. Since wet suppressants often have very little residual effect once the fluid dries, it is necessary to keep applying the suppressant, which can be expensive and time consuming.

A particular type of wet suppressant is a tackifier, which works by binding the dust particles together, forming larger pieces that are heavier and less susceptible to being disturbed. However, the tackifier ceases to be effective once it dries out, which can happen too quickly for many practical applications. Another drawback is that the materials typically used as tackifiers, such as crude oil, tall oil and tallow, can contaminate the substrate to which they are applied, as well as possibly contaminating the local environmental if any residual tackifier is washed off of or leaches out of the substrate.

Persistence of the suppression effect is therefore a concern. If an applied suppressant has little or no residual effect, it must be applied more frequently, demanding higher costs in materials, equipment and time required to ensure continuous protection. To address this concern, it is known to use polymer-based materials to form a more permanent coating over the substrate. Some materials that have been used are vinyl copolymer, acrylics, DirtGlue®, guar gum and acidulated soybean oil soap stock. Typically applied as water-based emulsions, the polymers begin to cross-link once the water evaporates, eventually creating a hard, inflexible coating or crust over the substrate. Once the crust is fully formed, it is typically permanent, as the polymeric cross-linked bonds are strong and generally difficult to break. A drawback of the polymer-based suppression systems is that the cross-linked polymer coating is generally not biodegradable, and is usually a foreign substance, not found in the immediate environment of the substrate. Another drawback is that for some substrates, such as those in storage applications (tailings ponds, for example) and transportation applications (as moving railcars, for example) a less-permanent cover is desirable, so that the substrate material can be accessed, moved, processed or used as necessary.

U.S. Patent Pub. No. 2005/0245678 to Marsden is one example of a polymer-based suppression system. Marsden discloses the use of a polymer containing —OH groups, such as starch, guar gum or xanthum gum, cross-linked with an agent such as glyoxal or a heavy metal-based cross-linker. Although Marsden indicates that the final coating produced with these chemicals is water insoluble and biodegradable despite the presence of heavy metal cross-linkers, it results in a very hard layer that cannot be easily broken up for further processing of the substrate. Marsden specifies that the pH of the liquid suppressant should be adjusted to below 4.5, thereby requiring special equipment and protocols to apply the acidic material. Marsden also specifies that the liquid must be maintained at a relatively low viscosity (at or below 500 centipoise) to enable application using conventional spraying techniques. This can restrict the parameters, including time and temperature, under which the liquid must be applied to the substrate.

U.S. Pat. No. 5,125,770 to Hesseling discloses a starch-based suppressant composition including a surfactant which dries to form a poorly water-soluble, resilient crust on the surface of a substrate. Alkaline substances, such as ammonia and/or borax, can be used to improve the dispersability of the liquid suppressant, and to improve the characteristics of the coating. Hesseling discloses a complicated process of mixing these ingredients together, drying them, remixing with surfactant and water glass, re-drying the mixture and grinding up the resulting product to form a dry mixture. The dry mixture can then be dissolved in water at an application site, but requires approximately 30 minutes of constant agitation to allow all of the dry mixture to completely dissolve before the composition can be applied to the substrate. The powder-based composition evidently requires a ready water source at the suppressant application site. The actual process appears to be directed to creating a powder-form composition that can be hydrated in site to produce a crust material, and therefore requires much time and effort to mix, dry and then grind the various components and mixtures formed. In addition, the 30 minute agitation requirement and the demand for water increases the equipment, effort and money spent to stabilize a substrate Further, because the crust needs to completely dry before proper protection is achieved, the substrate and the crust are susceptible to damage until the crust is completely dry, which can take several hours to a few days. Hesseling asserts that the substrate eventually loses its effectiveness after about 4-6 weeks, which may be more or less time than required.

U.S. Patent Pub. No. 2006/0243946 to Wolff discloses a starch-based suppressant that forms a fluid layer over the substrate and then dries to form a crust. According to Wolff, surfactants may be used to aid in spreading and penetration of the suppressant prior to crust formation, and cross-linking agents such as glyoxal or borax may be added to increase crust strength. Wolff also contemplates adding glycerin to the suppressant composition as a plasticizer. However, as noted above, typical spray applicators are suitable only to transmit liquids having a relatively low viscosity. Wolff discloses a composition which quite quickly becomes relatively viscous at ambient temperatures, due to the presence of the cross-linking agents. In order to prevent the increased viscosity from affecting the application of the suppressant, Wolff discloses applying the suppressant at temperatures which may be from approximately 40° C. to 60° C. or higher, to ensure that it can be applied using spray techniques. This restricts the seasons and times during which the suppressant may be applied, as well as demanding more energy and more sophisticated equipment to maintain and apply the suppressant at an elevated temperature. As with the suppressant described by Hesseling, the crust needs to completely dry in order to provide full protection, delaying the stabilization process.

It is therefore an object of the invention to provide a compound to form a flexible crust for a substrate that overcomes the foregoing deficiencies.

It is a further object of the invention to provide a compound to form a flexible crust that can be applied under most practical working conditions.

It is a further object of the invention to provide a compound to form a flexible crust in which the viscosity of the compound over time can be controlled, in order to customize the properties of the flexible crust.

It is a further object of the invention to provide a compound to form a flexible crust that can be broken up and worked into the substrate, without contaminating the substrate, allowing access to and further processing of the substrate material.

It is yet a further object of the invention to provide a compound to form a flexible crust that is non-toxic and environmentally safe.

These and other objects of the invention will be appreciated by reference to the summary of the invention and to the detailed description of the preferred embodiment that follow. It will be noted that not all objects of the invention are necessarily realized in all possible embodiments of the invention as defined by each claim.

### SUMMARY OF THE INVENTION

The invention relates to a binary stabilization compound which forms a complex matrix that binds with the top layer of a substrate, effectively producing a flexible crust. The substrate may be any material susceptible to producing dust or other particulate matter that can be blown or washed away, or a material that requires stabilization. Upon mixing, the components of the stabilization compound begin to complex, or form weak bonds, such that the viscosity of the compound increases at a controlled rate.

Controlling the rate of viscosity increase allows the viscosity increase to occur predominantly within the substrate, rather than within the holding, mixing or application apparatus, thereby simplifying the application process. It also allows the compound to be tailored to specific applications, as the viscosity can affect the depth to which the compound penetrates the substrate and overall thickness of the crust, as well as the concentration of substrate particles embedded in the crust matrix. Various additives may also be used to tailor the properties of the crust to a specific application, to application conditions and/or to an application process.

Once formed, the crust significantly reduces the amount of substrate material that can form dust, by binding the top layer of the substrate material within the crust matrix. The substrate is therefore less susceptible to movement or removal due to wind or water or other effects. However, because the crust is only weakly cross-linked, it can be physically broken up if it is manipulated mechanically, so the substrate can be accessed easily if required for further processing. Nor does the crust contain any strong or toxic chemicals, so it can be incorporated directly into the substrate material without adversely affecting the properties or value of the substrate.

In one aspect, the invention comprises a method of stabilizing a substrate of aggregate material comprising the steps of providing a first component comprising a polysaccharide and a second component comprising an aqueous mixture containing a borate provider; providing an alkaline agent as an ingredient in said first or said second component; delivering said first and second components to a staging area associated with said aggregate material; mixing said first and second components into a liquid compound at said staging area; applying said liquid compound to the surface of said aggregate material before said compound undergoes a substantial increase in viscosity, whereby to allow said liquid compound to penetrate said substrate prior to said increase in viscosity.

In a further aspect, the method may comprise the further steps of predetermining a desired delay period for the liquid compound to reach a maximum viscosity; and adding a retardant to said liquid compound, in an amount effective to correlate said increase in viscosity to said desired delay period.

In a further aspect, the invention may comprise the further steps of using additives such as a surfactant or glycerine to either of the first or second components.

In another aspect, the invention comprises a method of forming a stabilization crust on a substrate comprising the steps of combining a first component with a second aqueous component, said first component comprising a polysaccharide and said second component comprising a borate provider, to form a compound; applying said compound to said substrate; allowing said compound to penetrate said substrate to a pre-determined depth, thereby forming said stabilization crust; wherein said compound further comprises an alkaline component in an amount effective to facilitate release of borate into said compound from said borate provider. The pre-determined depth may be throughout the substrate or may be up to approximately 10 cm. The crust may form substantially independently of any evaporation of ingredients of said first and second components.

The mixing step may be carried out prior to or during said step of applying said liquid compound, and a single or dual-nozzle spray applicator may be used to carry out said mixing and applying steps. The step of applying said compound can be carried out at an ambient temperature range of −5° C. to +40° C.

In yet another aspect, the invention comprises a substrate stabilization compound comprising a first component, comprising a polysaccharide, which may be a starch, and may further be a modified starch; a second aqueous component, comprising a borate provider; an alkaline component in either said first component or said second component, in an amount effective to facilitate release of borate from said borate provider; wherein mixing said first and second components forms cross-links within said compound at a controlled rate; and wherein said compound is immediately applicable to a substrate. The alkaline component, which may be a hydroxide, selected from the group comprising sodium hydroxide, ammonium hydroxide and potassium hydroxide, may be selected to provide a pH of at least 12 to the compound. The controlled rate is preferably selected to allow a majority of said cross-links to form within said substrate.

Additives, such as a retardant, which may be selected from the group comprising water, alcohols and glycols, may be added to manipulate said controlled rate.

The foregoing was intended as a broad summary only and of only some of the aspects of the invention. It was not intended to define the limits or requirements of the invention. Other aspects of the invention will be appreciated by reference to the detailed description of the preferred embodiment and to the claims.

### BRIEF DESCRIPTION OF THE DRAWINGS

The preferred embodiment of the invention will be described by reference to the drawings in which:

FIG. 1 is a flowchart showing the preferred steps in the method to create a stabilization compound;

FIG. 2 is a graph showing the viscosity (centipoise) versus time (minutes) of various compounds made according to the invention as well as some reference compounds;

FIG. 3 is a table showing the viscosity of various polysaccharides dissolved in water;

FIG. 4 is a table showing the viscosity change over time of various polysaccharide compounds prepared according to the invention; and

FIG. 5 is a table showing qualitative results of crust formation tests performed on various polysaccharides.

### DETAILED DESCRIPTION OF THE INVENTION

The stabilization compound of the invention comprises two main components, which are preferably mixed just prior to application onto the substrate. In the preferred embodiment, the viscosity of the compound begins to increase at a controlled rate, as a result of the complexation, or weak bonding, that begins within the compound upon mixing.

Because the rate of viscosity increase is controlled, it is possible to apply the stabilization compound using any known application means, including various spray applicators. Spray applicators configured in various ways may be used, including an external dual spray gun where the two components are mixed as they leave the gun nozzles. Alternatively, the two components may be mixed just before they leave the gun nozzles. If further ingredients are employed to control the increase in viscosity, it is also possible to pre-mix the ingredients and apply them with a single nozzle applicator.

The first main component of the stabilization compound is a mixture containing 0.1 to 15% by weight of a polysaccharide such as starch, a modified starch or other polysaccharide. Suitable polysaccharides include starches having amylase or amylopectin, alpha- or beta-glucan, cellulose, dextrans, pectin, chitosan, modified glucan including glucan with gluten protein, acid- or alkaline-treated starch, enzyme-treated starch, bleached starch, oxidized starch, monostarch phosphate, distarch glycerol, distarch phosphate esterified with sodium trimetaphosphate, phosphated or acetylated distarch phosphate, starch acetate esterified with acetic anhydride or vinyl acetate, acetylated distarch adipate or glycerol, hydroxypropyl starch, hydroxypropyl distarch phosphate, hydroxypropyl distarch glycerol, starch sodium octenyl succinate, carrageenan and gums including xanthan gum, guar gum, guaran, carob gum and locust bean gum. The first component is preferably an aqueous mixture, encompassing aqueous polysaccharide solutions, dispersions or any other combination of polysaccharide in a flowable medium; however, the first component may be a dry powder mixture of a polysaccharide, such as starch alone or starch mixed with guar gum, in a 20:1 ratio. A dry powder mixture would be mixed with water at a staging area associated with the aggregate material to be stabilized. A suitable mixture of starch/guar gum powder would be 0.5% to 5% powder in water.

The second component of the stabilization compound is also preferably an aqueous mixture containing approximately 0.1-20% of a borate provider, such as borax or boric acid.

Once the two components are combined to form the stabilization compound, the polysaccharide molecules, particularly the glucose molecules, begin to link with the borate supplied by the borate provider at a controlled rate. This process, referred to as complexation, forms weak covalent bonds, comparable to weak cross-links in a polymer, within the polysaccharide matrix, as shown in the following diagram:

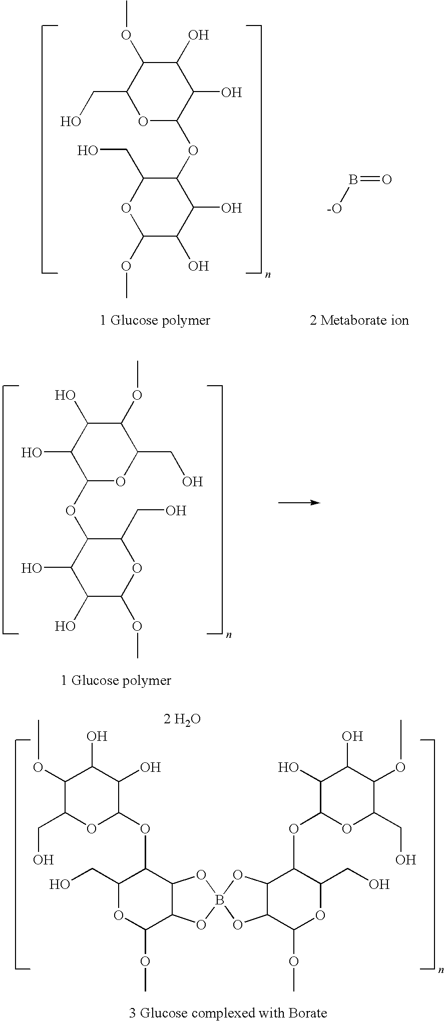

The complexation reaction results in an increase of viscosity throughout the mixture as starch molecules bond with borates. The bonds formed by the complexation reaction are preferably weaker than those formed when a conventional cross-linker is added to a starch solution. The immediate result is a liquid gel; over time, the liquid gel continues to cross-link until a final matrix is formed. The final matrix has some strength and flexibility, but does not become extremely hard or substantially indestructible. Nor does the matrix necessarily form a completely cohesive, closed film.

Further, matrix formation is controlled by the rate and amount of polysaccharide-borate cross-linking within the mixture. The matrix therefore forms relatively quickly; it is in fact formed well before the aqueous carriers are substantially evaporated. This shortens the time before complete protection is provided, as complete evaporation of a water-based carrier can take 72 hours or more. This provides a substantial advantage in wet conditions, as the matrix will soften if it is dampened or soaked with water, but it will maintain its inherent cross-linked structure, and will therefore re-harden once the added water evaporates. This property is useful in conditions such as heavy rainfall, or a river overflowing its banks.

Either solution may be modified by addition of a caustic, such as sodium hydroxide, ammonium hydroxide or potassium hydroxide, in order to increase the amount and rate of cross-linking. The caustic improves the release of borate from the borax or boric acid in solution, as borax and boric acid tend to polymerize in alkaline solutions, creating more borate ions to cross-link with the starch molecules. Depending on the particular starch used, a suitable amount of caustic is preferably in the range of up to 20%, for a borax solution, preferably a 2% caustic to 2% borax ratio. The effect of the caustic is to increase the pH of the borax solution, which leads to an increased level of borate being released, which in turn improves the complexation rate with the starch. If boric acid is used, a slightly higher level of caustic is generally required, in the range of 2% caustic to 0.96% boric acid. Typically, a more alkaline mixture will create a more effective cross-linking reaction. A pH level in the range of 9 or higher, preferably around 12, will produce good results.

The complexation reaction can be controlled by changing the ingredients in the two main components of the stabilization compound. Adding a retardant to delay or slow the rate at which the stabilization compound increases viscosity can be beneficial, in that it is not always feasible to apply a mixture immediately after combining the solutions. Further, having the compound viscosity increase within the layers of the substrate allows the depth of penetration to be controlled and allows the compound to be manipulated and applied under practically any circumstances without the need for heating or mixing.

Either solution may therefore be modified by adding a retardant to slow the complexation reaction. This allows the rate of complexation and the corresponding increase in viscosity of the resulting mixture to be controlled according to the needs of the specific application. For example, the soak time, during which the mixture is flowable enough to penetrate the substrate to which it is applied, can be adjusted by controlling the rate of increasing viscosity. By adjusting the soak time, the amount of interaction of the mixture with the substrate (including the depth of penetration of the mixture into the substrate) can be controlled, allowing the amount of substrate material captured by the mixture and encapsulated in the final crust matrix to be controlled. The flexibility and toughness of the resultant crust is also impacted by the amount of substrate material within the crust matrix and can therefore be controlled by controlling the soak time. The soak time is therefore dependent on the application and, to some extent, the particle size within the aggregate material. For example, for dust control applications with very fine particles of dust, 1 cm may be a sufficient depth of penetration to prevent dust from escaping the substrate. In extreme dusting circumstances, up to approximately 3 cm may be preferred to provide adequate dust control. In a soil stabilization application, deeper penetration is likely required, and would likely be to a depth at least equivalent to the average size of the particles within the substrate, in order to entrain particles within the crust matrix. In applications where the substrate is under a very high wind force, such as in moving rail cars carrying coal or other aggregate material, the required depth of penetration may be even deeper, possibly in the range of 15 to 20 cm. The properties of the compound can be controlled to provide penetration of up to 10 cm, or even completely through the depth of the substrate, as required by the application and aggregate material.

Different retardants can be added in different amounts, allowing the mixture properties to be further tailored for the application. Preferred materials for the retardant include water, alcohols, such as methanol, and glycols, such as propylene glycol. Water has the advantage of being inexpensive, environmentally friendly, and generally available at most application sites. However, although water can be used at most application temperatures, it is less suitable for sub-zero applications. An alcohol with a lower freezing point can be used in that case, to lower the freezing point of the main solutions and to ensure that the mixture remains flowable for as long as necessary. Good retardant and freezing point suppression results have been observed with ranges of 1-30% of methanol and glycol. The resulting compounds can then be applied at most practical working temperatures, including the preferred range of −5° C. to +40° C.

Another possible additive is a surfactant, which will generally improve the wetting ability of the stabilization compound, affecting the depth of permeation of the compound into the substrate. Some preferred surfactants include alkyl ethoxylates, alkyl propoxylates, block EO/PO, alkyl sulfonates and/or benzyl sulfonates. Generally, a surfactant is preferably added in approximate concentrations of up to 25% of the compound. Depending on the application, a surfactant type and concentration may be chosen to provide the desired substrate penetration and to be compatible with the substrate.

If a more flexible crust is preferred, glycerine or a similar plasticizer can also be added to the crust to increase the flexibility. Glycerine may be added to either component and can be present in the mixture at a concentration of up to 50%. Glycerine may also have a freezing-point suppressing effect.

Because the compound properties can be controlled very closely, the compound itself can be applied under most practical working conditions, without the need to wait once the solutions are combined. This saves man-hours, as it allows more substrate to be protected in a given time. Conversely, the solutions can be modified to allow for a longer time prior to forming the final matrix, if it is necessary to pre-mix the solutions. This might happen, for example, if a mixture is being applied from an airborne vehicle, such as a helicopter, where it would be preferable to simply spray the final mixture, instead of being concerned with carrying the various solutions and having to combine them in the proper proportions immediately before application.

As noted above, the stabilization compound can also be modified so that it is applicable even at temperatures below the freezing point of water, without the need for special equipment to heat the mixture before applying. Conversely, the stabilization compound can be modified to be unaffected by higher atmospheric temperatures.

The stabilization compound can also be applied with any equipment. Because the viscosity increase is generally controlled to provide some small delay, the solutions can be mixed in a mixing vessel before entering a spray applicator, without gumming up the applicator. The solutions might also be mixed in a mixing chamber just as they enter the spray applicator, or even within the spray applicator nozzle. Alternatively, the solutions can be mixed as they exit the nozzles of a dual-nozzle spray applicator, because the viscosity increase is not delayed by a long period. Again, any typical application system may be used, as no special equipment or supplies are required to heat or mix the compound.

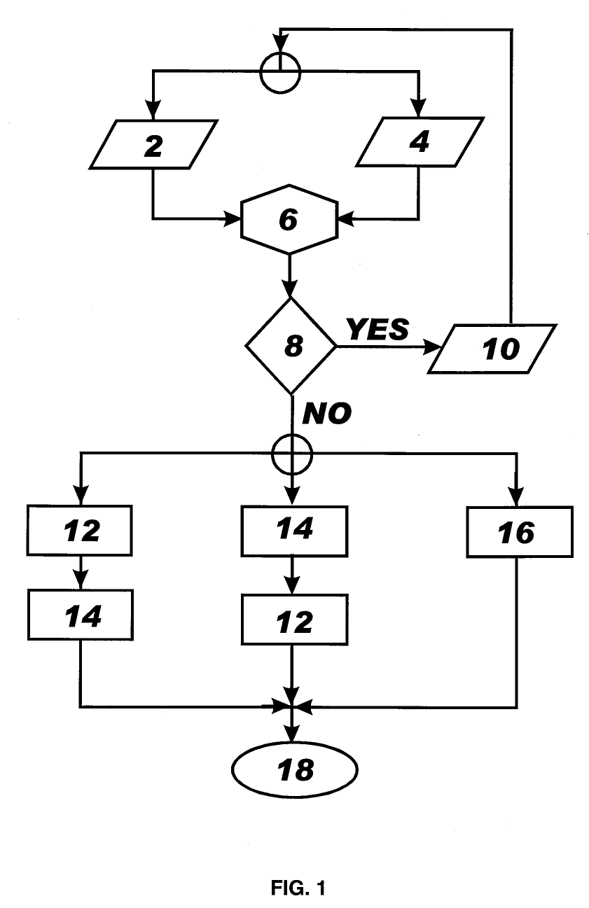

The method of making the stabilization compound is shown in the flowchart in FIG. 1. A first component 2 comprising a polysaccharide and a second component 4 comprising an aqueous mixture containing a borate provider are provided, along with an alkaline agent as an ingredient in either the first or second component. The separate components are delivered 6 to a staging area associated with the substrate to be stabilized, such as a tailings pond or other suitable location. The staging area may also be a site from which an airborne applicator, such as a helicopter, can be loaded and launched. If a significant delay 8 is required between the time of mixing and the time of application, retardant 10 may be added to either of components 2 and 4 at the staging area or before delivery thereto. At the staging area, the first and second components are mixed 12 to create a liquid compound. The liquid compound is applied 14 to the surface of the substrate before the compound undergoes a substantial increase in viscosity and while the compound can still easily be distributed over the substrate, and will be able to penetrate the substrate; the liquid compound can therefore reach the desired penetration depth within the substrate before the compound reaches a high viscosity, at which it is essentially no longer flowable. At this point, crust 18 has been formed. Alternatively, mixing 12 can take place any time subsequent to application 14. This might occur, for example, if component 2 is applied to the substrate first, followed by component 4, or if a dual nozzle applicator is used. In the further alternative, the mixing and application processes can be combined into a single process 16.

The method may be modified by predetermining a desired delay period for the liquid compound to reach its maximum viscosity and adding a retardant to the liquid compound, in an amount effective to correlate the time before the compound undergoes a substantial increase viscosity to that desired delay period

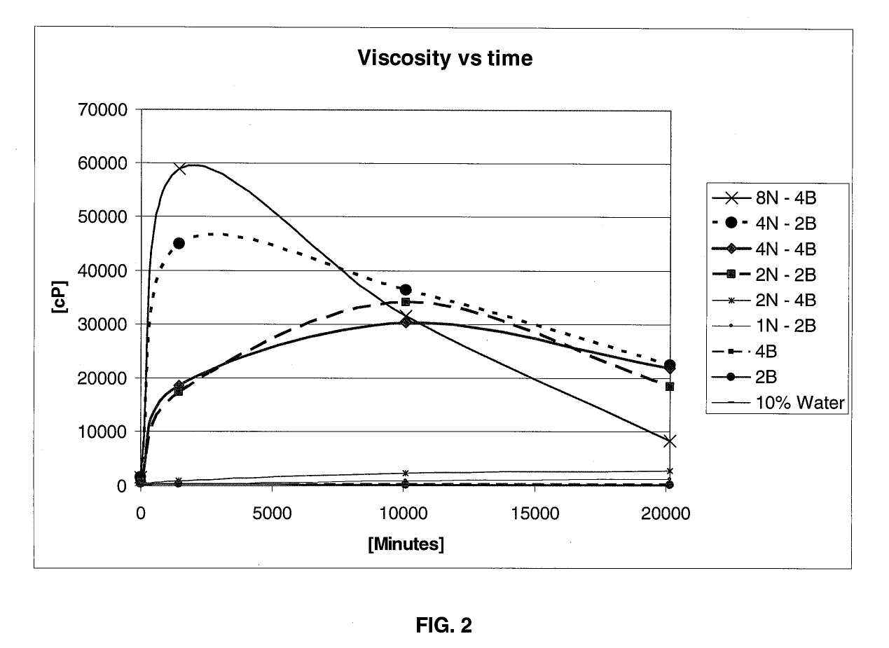

Controlling the rate of viscosity change in the stabilization compound is important in producing a final crust having the desired properties. As shown FIG. 2, the viscosity over time of stabilization compounds having similar components, in varying ratios, can produce compounds having different maximum and minimum viscosities, which are reached at different times. Stabilization compounds can therefore be tailored for various applications and applications conditions. In FIG. 2, the viscosity of the liquid gel formed from the compound is plotted against time. The lines represent different borax to caustic ratios, each tested in a solution having a starch concentration of 4%. xB indicates the amount of borax in the second component. For example, 2B indicates 2% borax in the second component. As the liquid gel is made up of 90% of the starch component and 10% of the second component, 2B denotes a compound having 0.2% borax. Similarly, xN stands for percent caustic (in this set of compounds sodium hydroxide (NaOH) is the caustic) in the second component. 4N-2B therefore denotes for a compound having 0.4% caustic and 0.2% borax. Generally, acceptable crusts were formed with borax to caustic ratios that exhibited a rapid increase in viscosity.

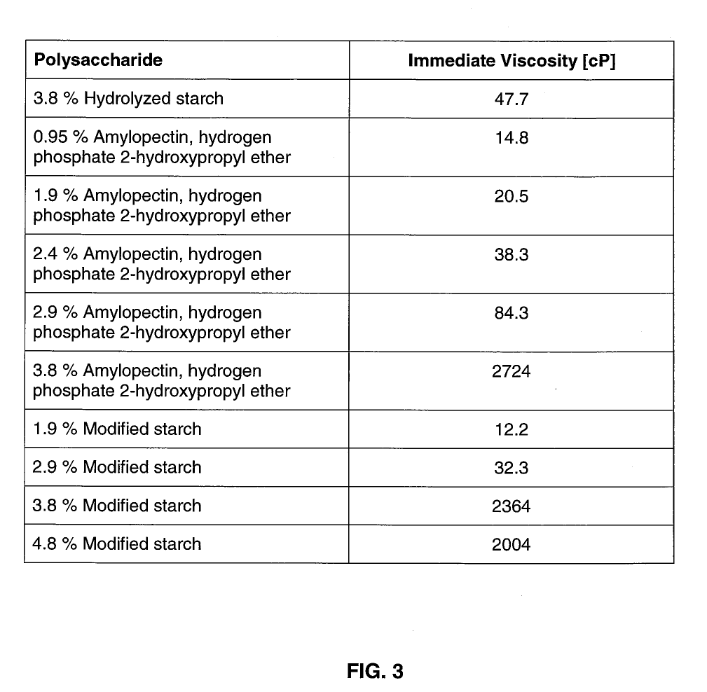

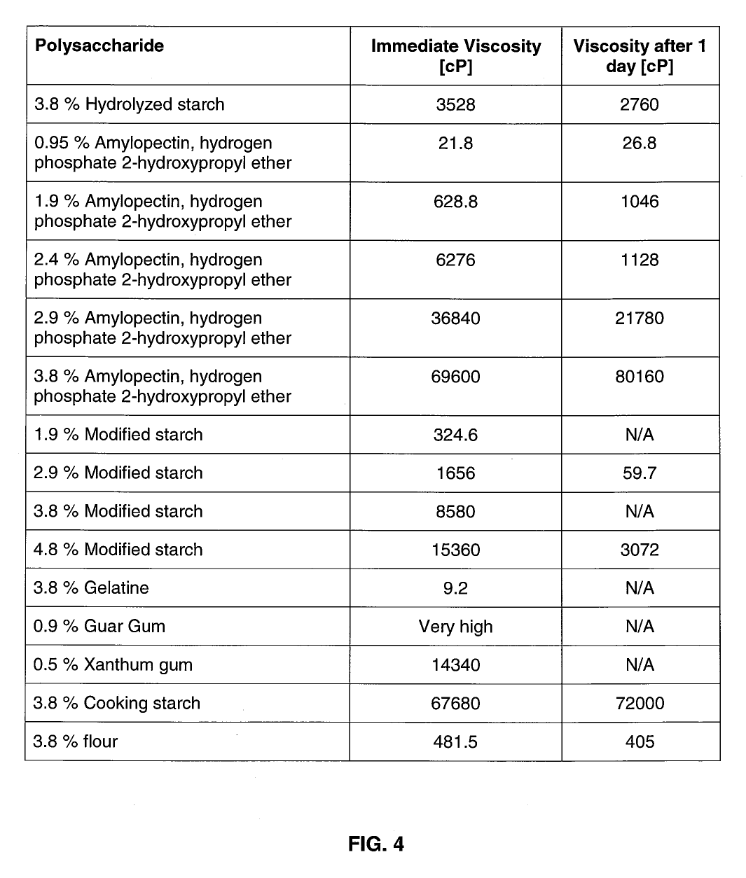

To test the effects of adding borax and caustic to a given polysaccharide, a given amount (in this case 456 g) of a polysaccharide listed in the first column of FIG. 4 was reacted with a fixed amount of caustic and borax (24 g of a 2% Borax and 2% NaOH solution) and stirred until the solution was well mixed, approximately 1-3 minutes. The viscosity was then measured to obtain the value listed in the “Immediate Viscosity” column. The effect of the borax and caustic addition on the viscosity of the compound can be seen by comparing the immediate viscosity results from FIG. 3, which shows the viscosity of a solution obtained when the various polysaccharides are simply mixed with water in approximately the same ratios as those used in FIG. 4.

It was determined that all of the listed polysaccharides formed an acceptable crust except for gelatine. These tests show that a polysaccharide can be chosen, and the concentration of the polysaccharide can be altered to provide the desired crust qualities, including maximum viscosity and the amount of time a particular crust will remain at that maximum viscosity, according to the particular stabilization application.

Crust-forming abilities were tested for several compounds by making sample rods. To make each rod, 9 g of substrate (in this case, nickel ore dust) was mixed with 1 g of a 4% stabilization compound in a mortar. The resulting mixture was pressed as tightly as possible into plastic tubes (6 mm diameter and 25 mm long). The samples were dried in the oven at 40° C. for three days, and then were cut out of the plastic tube. Crusting was evaluated using the pressure applied by two fingers on the sample rod.

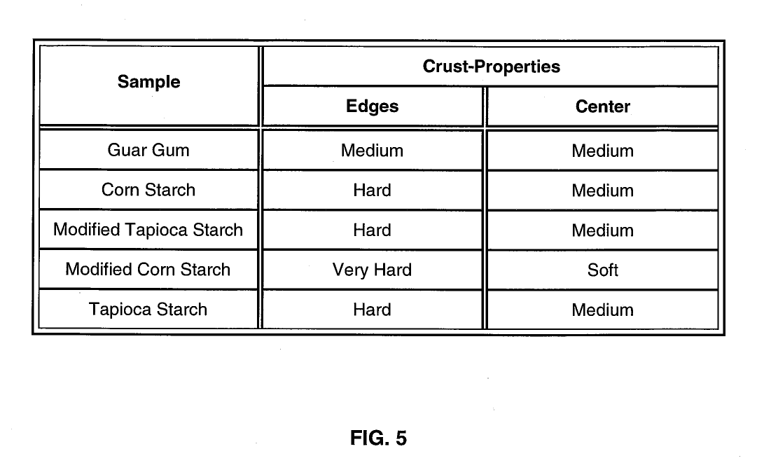

The crust formed in each rod was examined and characterized, as shown in FIG. 5, using the following qualitative categories:
Soft: sample falls apart easily without any applied force
Medium: minimal pressure of two fingers pulverizes the sample
Hard: some effort is needed to pulverize the sample
Very hard: the sample could not be pulverized by hand

It will be appreciated by those skilled in the art that other variations to the preferred embodiment described herein may be practised without departing from the scope of the invention, such scope being properly defined by the following claims.

What is claimed is:

1. A method of stabilizing a substrate of aggregate material comprising the steps of:
providing a first component comprising a polysaccharide;
providing a second component comprising an aqueous mixture containing a borate provider;
providing an alkaline agent as an ingredient in said first or said second component;
delivering said first and second components to a staging area associated with said aggregate material;
mixing said first and second components into a liquid compound at said staging area;
applying said liquid compound to the surface of said aggregate material before said compound undergoes a substantial increase in viscosity, whereby to allow said liquid compound to penetrate said substrate prior to said increase in viscosity.

2. The method of claim 1 comprising the further steps of:
predetermining a desired delay period for the liquid compound to reach a maximum viscosity; and
adding a retardant to said liquid compound, in an amount effective to correlate said increase in viscosity to said desired delay period.

3. The method of claim 1, wherein said step of mixing said first and second components is carried out during said step of applying said liquid compound.

4. The method of claim 3 using a dual-nozzle spray applicator to carry out said mixing and applying steps.

5. The method of claim 1 wherein said step of applying said compound is carried out at an ambient temperature range of −5° C. to +40° C.

6. The method of claim 1, wherein said first or said second component further comprises a surfactant.

7. The method of claim 1, wherein said first or said second component further comprises glycerine.

8. A method of forming a stabilization crust on a substrate comprising the steps of:
combining a first component with a second aqueous component, said first component comprising a polysaccharide and said second component comprising a borate provider, to form a compound;
applying said compound to said substrate;
allowing said compound to penetrate said substrate to a pre-determined depth, thereby forming said stabilization crust;
wherein said compound further comprises an alkaline component in an amount effective to facilitate release of borate into said compound from said borate provider.

9. The method of claim 8, wherein said step of combining said aqueous components is carried out prior to said step of applying said compound.

10. The method of claim 8, wherein said step of combining said aqueous components is carried out during said step of applying said compound.

11. The method of claim 10 using a dual-nozzle spray applicator to carry out said combining and applying steps.

12. The method of claim 8 wherein said step of applying said compound is carried out at a temperature range of −5° C. to +40° C.

13. The method of claim 8 wherein said pre-determined depth is up to 10 cm.

14. The method of claim 8 wherein said stabilization crust is formed substantially independently of any evaporation of ingredients of said first and second components.

15. A substrate stabilization compound comprising:
a first component, comprising a polysaccharide;
a second aqueous component, comprising a borate provider;
an alkaline component in either said first component or said second component, in an amount effective to facilitate release of borate from said borate provider;
wherein mixing said first and second components forms cross-links within said compound at a controlled rate; and
wherein said compound is immediately applicable to a substrate.

16. The compound of claim 15, further comprising a retardant to manipulate said controlled rate.

17. The compound of claim 16 wherein said retardant is selected from the group comprising water, alcohols and glycols.

18. The compound of claim 15 wherein said alkaline is a hydroxide.

19. The compound of claim 18 wherein said hydroxide is selected from the group comprising sodium hydroxide, ammonium hydroxide and potassium hydroxide.

20. The compound of claim 15 wherein said polysaccharide is a starch.

21. The compound of claim 20 wherein said starch is modified.

22. The compound of claim 15, further comprising glycerine.

23. The compound of claim 15, further comprising a surfactant.

24. The compound of claim 23, wherein said surfactant is selected from the group comprising alkyl ethoxylates, alkyl propoxylates, block EO/PO, alkyl sulfonates and benzyl sulfonates.

25. The compound of claim 15 wherein said controlled rate is selected to allow a majority of said cross-links to form within said substrate.

26. The compound of claim 15 wherein said alkaline component is selected to provide a pH level of at least 12 to said compound.
